(19) United States
(12) Patent Application Publication
(10) Pub. No.: US 2008/0316474 A1
(43) Pub. Date: Dec. 25, 2008

(54) Optical Apparatus and an Observation Apparatus Having the Same For Observing Micro Particles

(76) Inventors: Jun Keun Chang, Seoul (KR); Dae Sung Hur, Kyungsangbuk-Do (KR); Alexey Dan Chin-Yu, Seoul (KR); Seung Jin Her, Kyunggi-Do (KR); No Woong Kwak, Seoul (KR)

Correspondence Address: BROWDY AND NEIMARK, P.L.L.C.;624 NINTH STREET, NW, SUITE 300, WASHINGTON, DC, 20001-5303, US

(21) Appl. No.: 11/659,362

(22) PCT Filed: Jul. 28, 2005
(86) PCT No.: PCT/KR2005/002450

§ 371 Date: Feb. 5, 2007

(30) Foreign Application Priority Data
Aug. 4, 2004 (KR) 10-2004-0061300

(51) Int. Cl. G01N 21/88; F21V 7/00

(52) U.S. Cl. 356/237.4; 362/296

(57) ABSTRACT

Disclosed is an optical device for illuminating a chip having a sample provided thereto with a beam in an apparatus for observing the sample. The optical device comprises a light source; and a first reflector reflecting the beam of the light source to allow the reflected beam to be incident on the chip at an inclined angle. In addition, the invention provides an apparatus for observing micro particles having the optical device. When the light of the light source is incident on the sample at an incline angle according to the optical device of the invention, it is possible to maximize a transmittancy of the light. Accordingly, the light emitted from the sample is clearer and a clear image can be thus obtained.

### TECHNICAL FIELD

The present invention relates to an optical device for illuminating a chip having a sample provided thereto with a beam in an apparatus for illuminating the chip with the beam and reading-out light emitted from the sample to observe the sample. More specifically, the invention relates to an optical device comprising a light source generating a beam to be illuminated to the sample, and a first reflector reflecting the beam of the light source to allow the reflected beam to be incident on the chip at a predetermined inclined angle. In addition, the invention relates to an apparatus for observing micro particles having the optical device.

### BACKGROUND ART

In apparatuses for observing micro particles, optical devices for clearly photographing the micro particles have been developed.

FIG. 1 shows an optical section used for an apparatus of counting micro particles which is developed by Chemometek in Denmark. The optical section consists of a plurality of LEDs 111 to 114. Some LEDs 111, 112 are arranged above a sample chip 250 having a sample provided thereto and illuminates the sample chip 250 with light and some LEDs 113, 114 are arranged below the sample chip 250 and illuminates the sample chip 250 with light. The lights emitted from the LEDs 111 to 114 are incident on the sample chip 250 at an inclined angle of about 35° relative to a perpendicular direction of the chip.

A sample image formed by the lights emitted from the LEDs 111 to 114 is photographed by image photographing means 500 via an objective lens 400.

However, the optical device occupies a space too much since the plurality of LEDs are arranged. In addition, when a filter passing through only light having a wavelength region of 550 nm or less is used, a filter transmissivity T_{F} is 79% at the most, as can be seen from FIG. 2 and a table 1. In FIG. 2, the region with hatched lines are an area of passing through the filter.

TABLE 1

| Range of wavelength | | | | Qᵢ (λ) = |
|---|---|---|---|---|
| (λ) (nm) | P′ᵢ (λ) | Q′ᵢ (λ) | Pᵢ (λ) | Pᵢ (λ) × Q′ᵢ (λ) |
| 450-475 | 10 | 0.3 | 0.056 | 0.0168 |
| 475-500 | 30 | 0.6 | 0.167 | 0.1002 |
| 500-525 | 70 | 0.85 | 0.389 | 0.3310 |
| 525-550 | 70 | 0.95 | 0.389 | 0.3690 |
| | Σ P′ᵢ = 180 | | Σ Pᵢ = 1.0 | Σ Qᵢ = 0.82 |

T_{F} = filter transmittancy (0.96) × Q = 0.96 × 0.82 = 0.79

In the table 1,

P′ᵢ(λ) is luminosity of LED,

Q′ᵢ(λ) is excitation efficiency of propidium iodide (PI) which is fluorescent dye,

Pi(λ) is equivalent luminosity of LED, which is calculated by an equation of Pᵢ(λ)=P′ᵢ/ΣP′ᵢ=P′ᵢ/180, and

Qᵢ(%) is excitation efficiency of PI by LED.

### DISCLOSURE OF INVENTION

Accordingly, the present invention has been made to solve the above problems. An optical device of the invention comprises a first reflector reflecting a beam of a light source to allow the reflected beam to be incident on a chip at a predetermined inclined angle.

When the above optical device is used, it is possible to maximize a transmittancy of the light of the light source and to make light emitted from a sample clear, thereby obtaining an accurate image.

Accordingly, an object of the invention is to provide an optical device. In addition, another object of the invention is to provide an apparatus for observing micro particles having the optical device.

In order to achieve the above object, there is provided an optical device for illuminating a chip having a sample provided thereto with a beam in an apparatus for illuminating the chip with the beam and then reading-out light emitted from the sample to observe the sample, the optical device comprising a light source generating a beam to be illuminated to the sample; and a first reflector reflecting the beam of the light source to allow the reflected beam to be incident on the chip at an inclined angle.

According to an embodiment of the invention, the optical device may further comprise a second reflector re-reflecting the beam having passed through the chip to allow the re-reflected beam to be again incident on the chip at an inclined angle. At this time, the second reflector is preferably arranged at a position opposite to the first reflector on the basis of the chip.

According to an embodiment of the invention, the first reflector is preferably arranged so that the beam of the light source is incident on the chip at an inclined angle of 20° to 40° relative to a perpendicular direction of the chip. In addition, the second reflector is preferably arranged so that the beam having passed through the chip is re-reflected and then again incident on the chip at an inclined angle of 20° to 40° relative to the perpendicular direction of the chip. When the beam is inclinedly incident as described above, it is possible to maximize a transmissivity of the beam of the light source for the chip.

The inclined angle may be varied depending on a kind of the chip or transmitted light. For example, when a laser light is illuminated to a sample chip made of transparent plastic such as polymethylmethacrylate (PMMA), it is obtained a maximum transmissivity at an inclined angle of about 30° relative to the perpendicular direction. In addition, since the beam having passed through the sample chip is again incident on the sample chip by the second reflector, it is possible to maximize a quantity of light to be illuminated to the sample chip.

According to an embodiment of the invention, the optical device is preferably provided with an incident light-regulating lens between the light source and the first reflector, the lens being capable of regulating a size of the beam emitted from the light source and a focal distance. In addition, the optical device may further comprise an incident light filter passing through only light having a specific wavelength region of the lights emitted from the light source or an output light filter passing through only light of a specific region of the lights emitted from the sample.

According to an embodiment of the invention, the light source may be a laser light source or LED depending on a kind of micro particles to be observed. In particular, when dyeing the micro particles with a dye responsive to a fluorescent light such as propidium iodide (PI) so as to observe them, it is preferred to use the laser light source.

According to the invention, there is provided an apparatus for observing micro particles comprising: a light source section illuminating a sample chip having a sample including micro particles provided thereto with a beam; an objective lens abutting the chip so as to magnify a sample image formed by the beam illuminated from the light source section; means for photographing the sample image magnified through the objective lens; and an image reading-out section for reading-out the image photographed by the image photographing means.

According to the invention, the above described optical device is applied as the light source section.

### BRIEF DESCRIPTION OF DRAWINGS

The above and other objects, features and advantages of the present invention will be more apparent from the following detailed description taken in conjunction with the accompanying drawings, in which:

FIG. 1 is a view showing a structure of an optical device according to the prior art;

FIG. 2 is a view showing a transmittancy depending on wavelengths when using the optical device of the prior art;

FIG. 3 is a view showing a structure of an optical device according to an embodiment of the invention;

FIG. 4 is a view showing an illuminated area when a beam is illuminated using an optical device according to an embodiment of the invention;

FIG. 5 is a sectional view of a sample chip to which an optical device according to an embodiment of the invention can be applied; and

FIG. 6 is a view showing a transmittancy depending on wavelengths when using an optical device according to an embodiment of the invention.

### DESCRIPTION OF REFERENCE NUMERALS FOR IMPORTANT PART OF THE DRAWINGS

| | |
|---|---|
| 100: light source | 150: incident light-regulating lens |
| 200: first reflector | 250: sample chip |
| 300: second reflector | 400: objective lens |
| 500: image photographing means | 500: image reading-out section |

### BEST MODE FOR CARRYING OUT THE INVENTION

Hereinafter, an optical device and an apparatus for observing micro particles having the optical device according to a preferred embodiment of the present invention will be described with reference to the accompanying drawings. It should be noted that the invention is not limited to the embodiment. In the following description of the present invention, a detailed description of known functions and configurations incorporated herein will be omitted when it may make the subject matter of the present invention rather unclear.

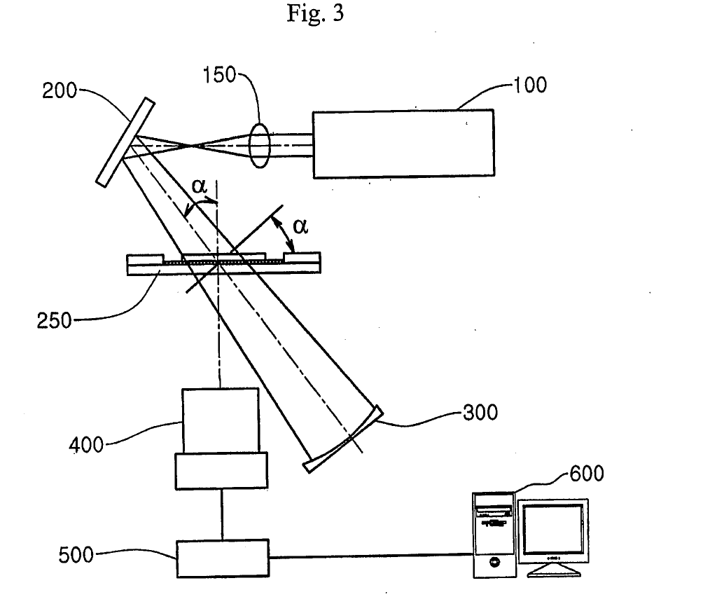

FIG. 3 is a view showing a structure of an optical device according to an embodiment of the invention.

The shown optical device is an optical device for illuminating a chip 250 having a sample provided thereto with a beam and comprises a laser light source 100 emitting a laser beam to be illuminated to the sample, and a first reflector 200 reflecting the beam of the light source 100 to allow the reflected beam to be incident on the chip 250 at a predetermined inclined angle (α) relative to a perpendicular direction of the chip.

A laser light source having a power of 20 mW and emitting a beam having a diameter of 1 mm is used as the light source.

In addition, a second reflector 300 is further provided which re-reflects the beam having passed through the chip 250 to allow the re-reflected beam to be again incident on the chip 250 at the inclined angle (α). At this time, the first and second reflectors 200, 300 are opposite to each other on the basis of the chip 250.

An incident light-regulating lens 150 capable of regulating a size of the beam emitted from the light source and a focal distance is provided between the light source 100 and the first reflector 200. A transmissivity (T_{L}) of the incident light-regulating lens 150 is about 0.98. The lens magnifies a size of the beam from the light source 100 by three times.

The beam having been reflected by the first reflector 200 is incident on the chip 250 at the inclined angle (α) of 20° to 40° relative to the perpendicular direction of the chip. In addition, the light having been incident on the chip 250 penetrates the chip 250 and is then re-reflected by the second reflector 300 and again incident on the chip at the inclined angle (α) of 20° to 40° relative to the perpendicular direction.

A reflectivity (R_{M}) of the first and second reflectors is about 0.98.

When the light of the light source is incident on the chip 250 at the inclined angle (α) relative to the perpendicular direction of the sample chip, as described above, it is possible to maximize the quantity of light to be illuminated to the sample chip. The inclined angle may be varied depending on a kind of the chip or transmitted light. For example, according to an embodiment of the invention, the chip was made of polymethylmethacrylate (PMMA) and the transmissivity thereof was maximal when the inclined angle (α) was 32.5°.

A total amount of the lights illuminated to the sample chip can be represented as E_{Σ}=E_{direct}+E_{second}. Each of the amounts is as follows:

E_{direct}=P×T_{L}×Rm/A=2.35 mW/mm² [Equation 1]

E_{second}=E_{direct}×T_{PMMA}³×R_{M}=1.91 mW/mm² [Equation 2]

E_{Σ}=E_{direct}+E_{second}=4.26 mW/mm² [Equation 3]

wherein

P is energy of light source,

T_{L} is transmissivity of incident light-regulating lens,

R_{M} is reflectivity of first and second reflectors,

A is illuminated area on the sample chip, and

T_{PMMA} is transmissivity of sample chip.

When the laser of the light source is illuminated on the sample chip, micro particles dyed with a fluorescent material emit a fluorescent light having a specific wavelength. Accordingly, it is possible to obtain a sample image by detecting the emitted fluorescent light.

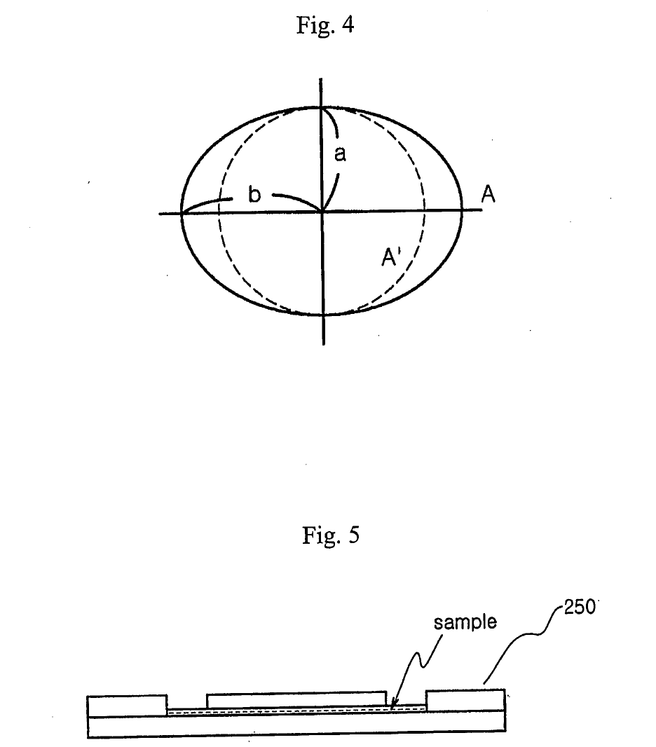

FIG. 4 is a view for explaining a relationship between a size of the beam and an illuminated area on the sample chip when the beam is incident on the sample chip at the inclined angle (α) relative to the perpendicular direction of the sample chip. An area of the beam A′ is πa² and an illuminated area on the sample chip A is nab πa²/cos α.

FIG. 5 is a sectional view of the sample chip used for the invention. The chip is made of PMMA and a refractive index η_{PMMA} is 1.494. Accordingly, the transmissivity T_{PMMA} can be obtained as follows:

T_{PMMA}=4η_{PMMA} cos α cos α′/[η_{PMMA} cos α′+cos α]=0.94 [Equation 4]

wherein α′=arcsin(sin α/η_{PMMA}).

An apparatus for observing micro particles according to the invention uses the above-described optical device as a light source section, and further comprises an objective lens 400 abutting the chip so as to magnify a sample image formed by the beam illuminated from the light source section, means 500 for photographing the sample image magnified through the objective lens, and an image reading-out section 600 for reading-out the image photographed by the image photographing means.

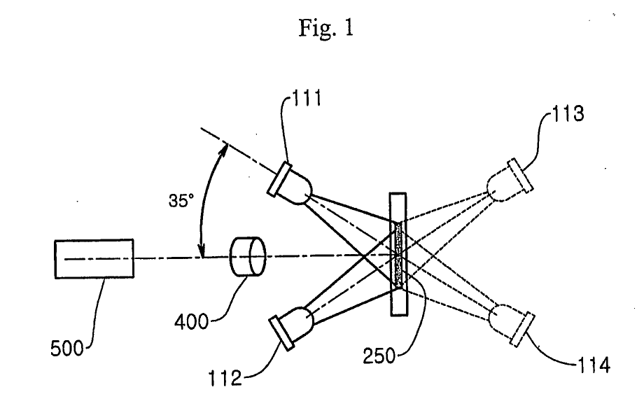

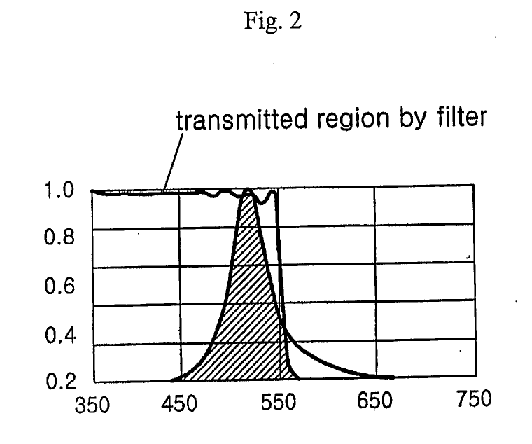

In the mean time, the quantity of light to be illuminated on the sample chip in the optical device of Chemometek as shown in FIG. 1 can be calculated as follows.

It is used a LED having a power of 5.4 mW and emitting a beam having a radius of 5 mm. An energy generated from each of the LEDs is E_{LED}÷(P×T_{F}/πr²) cos α<0.044 mW/mm², wherein P is an energy of the LED, T_{F} is filter transmission efficiency, r is a radius of the beam of the light source, and α is an inclined angle formed between the beam of the light source and the perpendicular direction of the sample chip.

When 30 LEDs are used, the maximum energy is 1.32 mW/mm².

Accordingly, the optical device of the present invention (maximum energy: 4.26 mW/mm²) can transmit more energy to the sample, compared to the prior optical device.

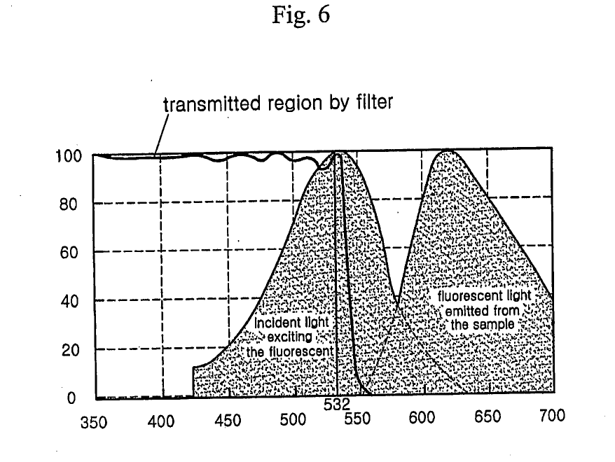

FIG. 6 is a graph showing a transmittancy depending on the wavelengths in an apparatus for observing micro particles using the optical device of the present invention.

In the graph, the laser beam (λ=532 mm) exhibits an efficiency of 98% and an energy exciting the fluorescent is E_{E}=E×Q=4.26 mW/mm²×0.98=4.17 mW/mm².

In the mean time, in a case of the optical device available from Chemometek, the energy exciting the fluorescent is E_{E}=E×Q=1.32 mW/mm²×0.82=1.074 mW/mm².

Accordingly, it can be seen that the quantity of light illuminated to the sample chip is maximized when using the optical device of the invention.

### INDUSTRIAL APPLICABILITY

As described above, according to the invention, when the light of the light source is incident on the sample at a predetermined inclined angle, it is possible to minimize a noise due to the light source and to maximize the energy efficiency. In particular, the quantity of light to be illuminated to the sample chip can be maximized by re-reflecting the light of the light source to the sample using the second reflector. Accordingly, the light emitted from the sample is clearer and a clear image can be thus obtained. As a result of that, it is possible to accurately observe and analyze the micro particles.

While the invention has been shown and described with reference to certain preferred embodiments thereof, it will be understood by those skilled in the art that various changes in form and details may be made thereto without departing from the spirit and scope of the invention as defined by the appended claims.

1. An optical device for illuminating a chip having a sample provided thereto with a beam in an apparatus for illuminating the chip with the beam and then reading-out light emitted from the sample to observe the sample, the optical device comprising:
a light source generating a beam to be illuminated to the sample; and
a first reflector reflecting the beam of the light source to allow the reflected beam to be incident on the chip at an inclined angle.

2. The optical device according to claim 1, further comprising a second reflector re-reflecting the beam having passed through the chip to allow the re-reflected beam to be again incident on the chip at an inclined angle, wherein the second reflector is arranged at a position opposite to the first reflector on the basis of the chip.

3. The optical device according to claim 2, wherein the light source is a laser light source.

4. The optical device according to claim 2, wherein the light source is an LED.

5. The optical device according to claim 1, wherein the first reflector is arranged so that the beam of the light source is incident on the chip at an inclined angle of 20° to 40° relative to a perpendicular direction of the chip.

6. The optical device according to claim 5, wherein an incident light-regulating lens regulating a size of the beam emitted from the light source and a focal distance is provided between the light source and the first reflector.

7. The optical device according to claim 5, wherein the sample chip is made of a transparent plastic material.

8. An apparatus for observing micro particles comprising:
a light source section illuminating a sample chip having a sample including the micro particles provided thereto with a beam;
an objective lens abutting the chip so as to magnify a sample image formed by the beam illuminated from the light source section;
means for photographing the sample image magnified through the objective lens; and
an image reading-out section for reading-out the image photographed by the image photographing means,
wherein the light source section comprises a light source generating a beam to be illuminated to the sample; and a first reflector reflecting the beam of the light source to allow the reflected beam to be incident on the chip at an inclined angle.

9. The apparatus according to claim 8, wherein the light source section further comprises a second reflector re-reflecting the beam having passed through the chip to allow the re-reflected beam to be again incident on the chip at an inclined angle, the second reflector being arranged at a position opposite to the first reflector on the basis of the chip.

10. The apparatus according to claim 9, wherein the light source is a laser light source or an LED.

11. The apparatus according to claim 8, wherein the first reflector is arranged so that the beam of the light source is incident on the chip at an inclined angle of 20° to 40° relative to a perpendicular direction of the chip.
